(19) United States
(12) Patent Application Publication
(10) Pub. No.: US 2024/0309591 A1
(43) Pub. Date: Sep. 19, 2024

(54) SKID-STREETS AND MOBILE MIXING SKID-STREETS ATTACHMENTS WITH SCOOP AND RELATED METHODS FOR FACILITATING PROCESSING AND INSTALLING OF ASPHALT

(71) Applicant: REEVES ENTERPRISES, INC, Albany, NY (US)

(72) Inventors: Mark C. Reeves, Slingerlands, NY (US); Edward F. Reeves, Newburg, NY (US); Norman M. Jelke, Honey Brook, PA (US); Charles G. Jelke, Honey Brook, PA (US); Kristofer J. Stichter, Lebanon, PA (US)

(21) Appl. No.: 18/264,110

(22) PCT Filed: Feb. 3, 2022
(86) PCT No.: PCT/US2022/015160

§ 371 Date: Aug. 3, 2023

Related U.S. Application Data
(60) Provisional application No. 63/145,151, filed on Feb. 3, 2021.

(51) Int. Cl. E01C 19/00; B01F 29/63; B01F 33/502; B01F 35/32; B01F 35/43; B01F 35/71; B01F 35/90; B01F 35/92; B01F 101/28; B01F 101/38; B28C 5/08; B28C 5/18

(52) U.S. Cl. CPC E01C 19/002; B01F 29/63; B01F 33/5026; B01F 35/32045; B01F 35/43; B01F 35/7131; B01F 35/7178; B01F 35/92; B28C 5/085; B28C 5/1862; B28C 5/1887; B01F 2035/99; B01F 2101/28; B01F 2101/38

(57) ABSTRACT

Mobile mixing attachments, skidsteers with mobile mixing attachments, mobile mixing devices and related methods are provided. A mobile mixing attachment for use on a skid-steer can include a rotatable mixing drum having a body that forms an internal cavity and having a forward end and a bottom end. The mixing drum can include a mouth at the forward end of the body that provides access to the internal cavity of the mixing drum. The mobile mixing attachment can include a drum chassis configured to hold and rotate the mixing drum and an attachment plate secured to a rear portion of the drum chassis proximal to the bottom end of the body. The attachment plate configured to engage one or more attachment couplers on lift arms of a skid-steer. The mobile mixing device also comprises a scoop comprising a forward scooping lip and a rear loading end positioned in front of the mouth of the mixing drum. The scoop is secured to the drum chassis.

### RELATED APPLICATIONS

The present patent application claims the benefit of PCT International Patent Application Serial. No. PCT/US2022/015160, filed Feb. 3, 2022, and U.S. Provisional Patent Application Ser. No. 63/145,151, filed Feb. 3, 2021, to which PCT International Patent Application Serial. No. PCT/US2022/015160 claims priority and benefit. The disclosures of both patent applications referenced above are incorporated herein by reference in their entireties.

### TECHNICAL FIELD

The present subject matter relates to skid-steers, mobile mixing skid-steer attachments and related methods for facilitating the processing and installation of asphalt. In particular, the present subject matter relates to skid-steers, mobile mixing skid-steer attachments and related methods that can facilitate the processing of asphalt using a scoop attachment to gather asphalt and funnel the gathered asphalt into the mouth of a mobile mixer attachment of a skid-steer as well as potentially providing other asphalt processing features.

### BACKGROUND

For nearly a century, roads, driveways, runways, and other such surfaces over which vehicles travel have often been constructed using various types of asphalt. The viscous nature of the bitumen binder generally used with most types of asphalt allows the asphalt (sometimes referred to as asphalt concrete) to sustain significant plastic deformation. To increase strength and durable ability, roads, driveways, runways, and other such surfaces over which vehicles travel are often constructed with a gravel, a cement or concrete subgrade surface to add strength and an asphalt top, sometimes referred to as blacktop, which can provide a better elasticity to the surfaces, better withstand weather changes, reduce road noises, wear better for increased longevity and wear less on the vehicle's tires. Although asphalt provides a fair longevity to such road surfaces, fatigue from repeated loading over time is a common failure mechanism along with erosion or changes to the subgrade.

When repairing such roads, driveways, runways, and other such surfaces over which vehicles travel, the repair crew often needs to use both of some type of cement or concrete to provide, strength or repair the subgrade and some form of asphalt to bring the damaged portion of the road surface to more acceptably usable standards. Thus, to currently perform such repairs no matter how large or small, repair crews need to bring multiple pieces of equipment to each jobsite just to mix and process the materials used to repair the road. For example, a cement mixer will be needed to mix and process materials such as cement, concrete or flowable fill used to form the repair subgrade. The repair crew will also need to haul asphalt from an asphalt plant or to bring along a separate and additional asphalt mixer, to mix the asphalt to be used to cover the repair subgrade. Due to the processing needs of each type of material, asphalt cannot be processed in a traditional cement mixer and cement, concrete or flowable fill generally cannot be processed in an asphalt mixer.

A mobile mixing attachment has been developed for the skid-steer that allows for asphalt to be heated and processed remotely at a site in need of repair. The mobile mixing attachment arm has a mixing drum that includes a mouth at a forward end and an enclosed bottom. The drum can be tilted upward and downward as needed. Additionally, in some embodiments, the attachment can include a heater secured by a heater support arm. However, to be able to efficiently process the asphalt with such a skid-steer having a mobile mixing attachment, two workers are needed: one to shovel asphalt, new or reclaimed, into the mouth of the drum of the mobile mixing attachment and one to operate the skid-steer and rotate the drum. For small, intermittent repairs, such as fixing potholes, having two workers to make such repairs is not cost effective for companies and state agencies in the transportation industry.

As such, a need exists for skid-steers and mobile mixing skid-steer attachments that can be used to quickly and easily process and install asphalt in a cost-effective manner.

### SUMMARY

The present subject matter provides mobile mixing devices, skid-steers, mobile mixing attachments, mobile mixing systems, and related methods. In particular, the present subject matter relates to mobile mixing attachments that can be used on construction vehicles such as skid-steers, that include a scoop and/or a tamping roller that will permit the construction vehicle to be operated by a single worker to make asphalt and/or fillable flow products for road surface repair.

Thus, it is an object of the presently disclosed subject matter to provide mobile mixing devices, skid-steers, mobile mixing attachments, mobile mixing systems, and related methods that can reduce cost, time, and labor associated with processing different types of materials used in road surface repair. While one or more objects of the presently disclosed subject matter having been stated hereinabove, and which is achieved in whole or in part by the presently disclosed subject matter, other objects will become evident as the description proceeds when taken in connection with the accompanying drawings as best described hereinbelow.

### BRIEF DESCRIPTION OF THE DRAWINGS

A full and enabling disclosure of the present subject matter including the best mode thereof to one of ordinary skill in the art is set forth more particularly in the remainder of the disclosures and the specification, including reference to the accompanying figures, in which:

FIG. 1A illustrates a partial side perspective view of an embodiment of a mobile mixing device in the form of skid-steer with a mixing drum attachment scooping repurposed asphalt material into the mixing drum according to the present subject matter;

FIG. 1B illustrates a side perspective view of the embodiment of the slid-steer with the mobile mixing attachment according to FIG. 1A with the mixing drum tilted upward and asphalt material on the scoop of the attachment according to the present subject matter;

FIG. 2A illustrates a top front left side perspective view of an embodiment of the mobile mixing attachment according to the present subject matter with an embodiment of a heater arm in a stow-away position;

FIG. 2B illustrates a top front right side perspective view of the embodiment of the mobile mixing attachment according to FIG. 2A with the embodiment of the heater arm in a heating position;

FIG. 2C illustrates a top front left side perspective view of the embodiment of the mobile mixing attachment according to FIG. 2A with the embodiment of the heater arm in a stow-away position;

FIG. 2D illustrates a top front right side perspective view of the embodiment of the mobile mixing attachment according to the present subject matter with the embodiment of the heater arm in a heating position;

FIG. 3A illustrates a cross-sectional view of the embodiment of the mobile mixing attachment according to FIG. 2A with a heater in a heating position;

FIG. 3B illustrates a schematic partial cross-sectional view of an embodiment of a mobile mixing attachment according to the present subject matter;

FIG. 3C illustrates a partial perspective view of embodiments of a tamping roll and a watering bar of the mobile mixing attachment according to the present subject matter;

FIG. 3D illustrates a partial perspective view of the embodiments of the tamping roll and a watering tank for supplying water to the water bar of the mobile mixing attachment according to FIG. 3C;

FIG. 4A illustrates a top plan view of the embodiment of the mobile mixing attachment according to FIG. 2A with the embodiment of the heater arm in a stow-away position;

FIG. 4B illustrates a top plan view of the embodiment of the mobile mixing attachment according to the present subject matter with the embodiment of the heater arm in a heating position;

FIG. 5A illustrates a left side plan view of an embodiment of the mobile mixing attachment according to the present subject matter with an embodiment of a heater arm in a stow-away position;

FIG. 5B illustrates a right side plan view of the embodiment of the mobile mixing attachment according to FIG. 2A with the embodiment of the heater arm in a heating position;

FIG. 5C illustrates a left side plan view of the embodiment of the mobile mixing attachment according to FIG. 2A with the embodiment of the heater arm in a stow-away position;

FIG. 5D illustrates a right side plan view of the embodiment of the mobile mixing attachment according to the present subject matter with the embodiment of the heater arm in a heating position;

FIG. 6A illustrates a front plan view of the embodiment of the mobile mixing attachment according to FIG. 2A with the embodiment of the heater arm in a stow-away position;

FIG. 6B illustrates a front plan view of the embodiment of the mobile mixing attachment according to the present subject matter with the embodiment of the heater arm in a heating position;

FIG. 6C illustrates a schematic partial cross-sectional view of an embodiment of a mixing drum of a mobile mixing attachment according to the present subject matter; and

FIG. 7 illustrates a rear plan view of the embodiment of the mobile mixing attachment according to FIG. 2A showing embodiments of connector plates and the embodiment of the heater arm in a stow-away position.

Repeat use of reference characters in the present specification and drawings is intended to represent the same or analogous features or elements of the present subject matter.

### DETAILED DESCRIPTION

Reference now will be made to the embodiments of the present subject matter, one or more examples of which are set forth below. Each example is provided by way of an explanation of the present subject matter, not as a limitation. In fact, it will be apparent to those skilled in the art that various modifications and variations can be made in the present subject matter without departing from the scope or spirit of the present subject matter. For instance, features illustrated or described as one embodiment can be used on another embodiment to yield still a further embodiment. Thus, it is intended that the present subject matter cover such modifications and variations as come within the scope of the appended claims and their equivalents. It is to be understood by one of ordinary skill in the art that the present discussion is a description of exemplary embodiments only, and is not intended as limiting the broader aspects of the present subject matter, which broader aspects are embodied in exemplary constructions.

Although the terms first, second, right, left, front, back, etc. may be used herein to describe various features, elements, components, regions, layers and/or sections, these features, elements, components, regions, layers and/or sections should not be limited by these terms. These terms are only used to distinguish one feature, element, component, region, layer or section from another feature, element, component, region, layer or section. Thus, a first feature, element, component, region, layer or section discussed below could be termed a second feature, element, component, region, layer or section without departing from the teachings of the disclosure herein.

Similarly, when a layer or coating is being described in the present disclosure as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Embodiments of the subject matter of the disclosure are described herein with reference to schematic illustrations of embodiments that may be idealized. As such, variations from the shapes and/or positions of features, elements or components within the illustrations as a result of, for example but not limited to, user preferences, manufacturing techniques and/or tolerances are expected. Shapes, sizes and/or positions of features, elements or components illustrated in the figures may also be magnified, minimized, exaggerated, shifted or simplified to facilitate explanation of the subject matter disclosed herein. Thus, the features, elements or components illustrated in the figures are schematic in nature and their shapes and/or positions are not intended to illustrate the precise configuration of the subject matter and are not intended to limit the scope of the subject matter disclosed herein.

It is to be understood that the ranges and limits mentioned herein include all ranges located within the prescribed limits (i.e., subranges). For instance, a range from about 100 to about 200 also includes ranges from 110 to 150, 170 to 190, 153 to 162, and 145.3 to 149.6. Further, a limit of up to about 7 also includes a limit of up to about 5, up to 3, and up to about 4.5, as well as ranges within the limit, such as from about 1 to about 5, and from about 3.2 to about 6.5 as examples.

“Construction vehicle” as used herein means any vehicle used in the construction industry that can be modified or constructed to incorporate an operable mixing drum such that the construction vehicle can serve a mobile mixing device. As used herein construction vehicles can include, but are not limited to, skid-steers, loaders, backhoes, tractors, flatbed trucks, dump trucks, cement mixer trucks, asphalt mixer trucks, or the like.

“Skid loader,” “skid-steer loader,” or “skid-steer,” as used herein means a vehicle that is a small rigid frame, engine-powered machine with lift arms used to attach a wide variety of labor-saving tools or attachments. Many manufacturers have their own versions of this vehicle, including Bobcat, Terex, Case, Caterpillar, Gehl Company, Hyundai, JCB, JLG, John Deere, Komatsu, LiuGong, New Holland, Volvo, Wacker Neuson, and others.

“Mobile mixing device,” “mobile mixing system”, or “mobile mixer” as used herein means a portable device or system that comprises a portable multiple purpose mixing drum that can be used to separately mix construction materials, such as cement or asphalt. “Mobile mixing device,” “mobile mixing system”, or “mobile mixer” can include, but are not limited to construction vehicles outfitted with the multiple purpose mixing drum, such as a skid-steer or the like with a mobile mixing attachment secured thereon.

“Mobile mixing attachment” as used herein is a device that can be attached to a construction vehicle, such as a skid-steer, that includes a drum for mixing asphalt or concrete on a site where the asphalt or concrete will be used.

A mobile mixer can be provided that can serve as a single mixing device both for mixing asphalt and for mixing concrete. In particular, the mobile mixer can heat bitumen, virgin asphalt, reclaimed asphalt pavement (RAP), pelletized asphalt, and/or other type mixtures of asphalt to produce asphalt hot mix on site.

When processing asphalt from a pile of asphalt material, such as a pile of reclaimed asphalt pavement (RAP) that has been scraped from the surface of the site being repaired, a mobile mixing device, or mobile mixer, such as a skid-steer with a mobile mixing attachment secured thereto with a scoop positioned in front of a mouth of a drum of the mobile mixing attachment, can be used to efficiently process the asphalt with such a skid-steer having a mobile mixing attachment with only one worker. A single worker can operate the skid-steer to load the drum heat the asphalt within the drum, rotate the drum, and unload and compact the contents from the drum as needed to make the required repairs. Thus, for small, intermittent repairs, such as fixing potholes, a single worker can make such repairs in a more cost effective manner for companies and state agencies in the transportation industry.

In particular, the scoop on the mobile mixing attachment allows the operator to scrape materials off the ground or scoop the recyclable materials from a pile and load it into the drum simply by tipping the drum of the mobile mixing attachment upwards, thereby providing a unique ability for a single worker or operator to scoop and load the asphalt recycler directly in an efficient manner. Once the material has been processed in the mobile mixing attachment and the processed asphalt material has been delivered to the repair site, the scoop can be used to spread and compact the material, for example, by blading or back-blading the material on the ground after discharge. When processing pelletized asphalt or concrete, the scoop can act as a platform for loading bags of such pelletized asphalt or concrete.

The scoop can bolt on/off of a drum chassis of the mobile mixing attachment in a position such that the scoop sits beneath the drum of the mobile mixing attachment. The scoop can have a unique shape that is flat at the leading edge and curves to the contour of the drum as it approaches the drum of the mobile mixing attachment. In this way, material is funneled into the circular drum opening, or mouth, without spilling onto the ground. The part of the scoop closest to the drum can tuck under the drum by about one (1) or two (2) inches but does not touch the drum. When loading the drum in this way, there may be a bit of spillage of material between the drum and the scoop (as there is a gap), but any such spillage is minimal compared to the scooped amount of material delivered into the drum. Usually during loading, the drum and scoop will be over a pile of material, so any such spillage is a non-issue. During unloading of the drum of the mobile mixing attachment, there will generally not be spillage, as the scoop tucks beneath the drum. The scoop is not attached to the drum of the mobile mixing attachment, but rather it is supported by a steel beam that runs back to the heavy-duty attachment plate that attaches the mobile mixing attachment to the skid-steer. In this way, when the skid-steer is driven into a pile of material, the impact is on the scoop and not on the drum, thereby protecting the drum, shaft and bearings.

A tamping roller can be provided below the drum on the bottom portion of the mobile mixing attachment to tamp and compact the material discharged at the repair site. The tamping roller can have a scraper to remove the sticky asphalt from the drum, and a watering bar with holes in it to keep asphalt from sticking. The tamping roller can be built from a heavy duty pipe with a shaft down the center supported by bearings that are affixed to the underside back edge of the machine. The tamping roller can be tucked up out of the way during normal operation and during scooping based on the orientation of the mobile mixing attachment. The tamping roller can be engaged with the ground by tipping the drum upward and lowering the mobile mixing attachment downward on its rear edge. The skid-steer with the tamping roller contacting the ground under force can then be driven forward and backward over the patch with downward machine pressure, compacting the fresh asphalt. Such a tamping roller can be used with small patches and potholes. The tamping roller is less useful with the patches that are wider than the distance between the wheels or tracks of the skid-steer since the wheel or track can leave tread marks in the asphalt. A mobile mixing device such as a skid-steer with a mobile mixing attachment with a scoop and/or a tamping roller provides an efficient mechanism for a single worker/operator to repair road and other finished surfaces.

In some embodiments, the mixing drum drive of the mobile mixing attachment can comprise a hydraulic drive system. For example, the mixing drum drive can comprise a hydraulic motor and a dampening block manifold with hydraulic lines in and out that have connectors for coupling to the hydraulic lines to be attached the hydraulic attachment lines of the skid-steer and in and out motor connectors for feeding hydraulic fluid to the hydraulic motor of the hydraulic drive system. The mixing drum drive can also comprise a double sprocket and chain drive attached to a shaft or shaft sleeve of the mixing drum. Once the hydraulic lines are attached to the hydraulic attachment lines of the skid-steer, hydraulic fluid can flow through the system into the hydraulic motor, which rotates a motor shaft attached to two drive sprockets that form a double drive sprocket. The double drive sprocket can drive a double chain that is also attached to a larger double driven sprocket that is, in turn, attached to the drum. For example, the two drive sprockets each drive a chain. The two chains each drive a large driven sprocket that are attached in tandem to the drum. For example, the two driven sprockets can be attached to a shaft or a shaft sleeve of the mixing drum. As the sprockets rotate, the drum is rotated. The dampener can include an aluminum block manifold which contains within it a pressure relief valve connected with hydraulic fittings to the hydraulic motor. The drum is often loaded with 500 or more pounds of material. When drum rotation is hydraulically stopped or started by an electrically controlled solenoid valve. When the drum is stopped, it stops almost instantly, which puts tremendous stress on the sprockets and chains. The hydraulic dampening system prevents damage to chain and sprocket by allowing the hydraulic pressure to be relieved through a pressure relief valve, during these sudden changes in drum rotation while the drum is under load.

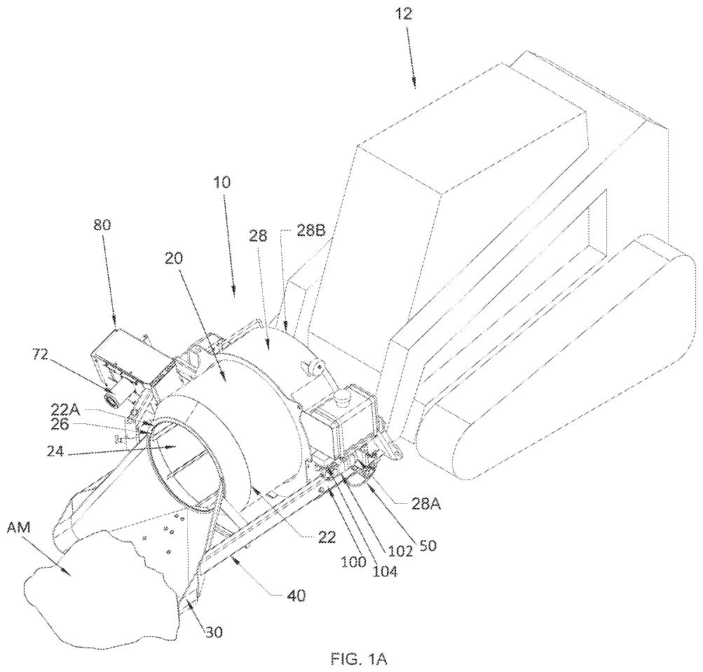

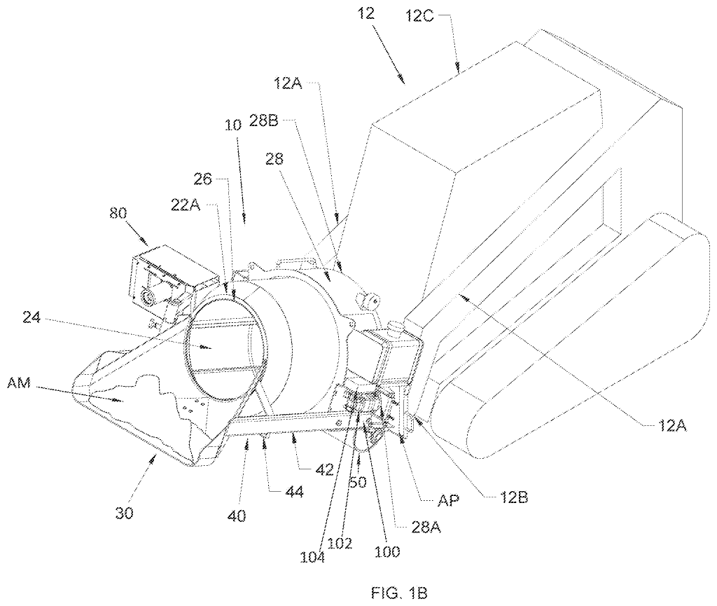

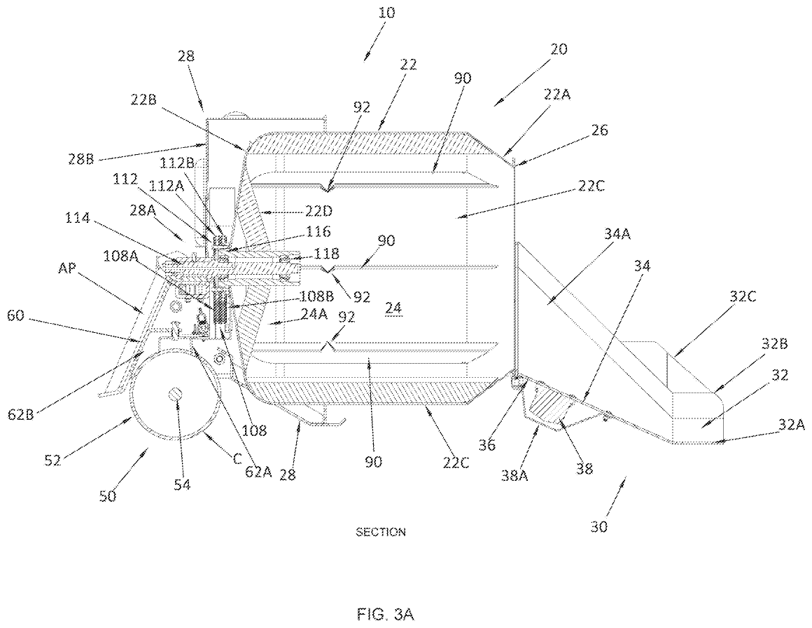

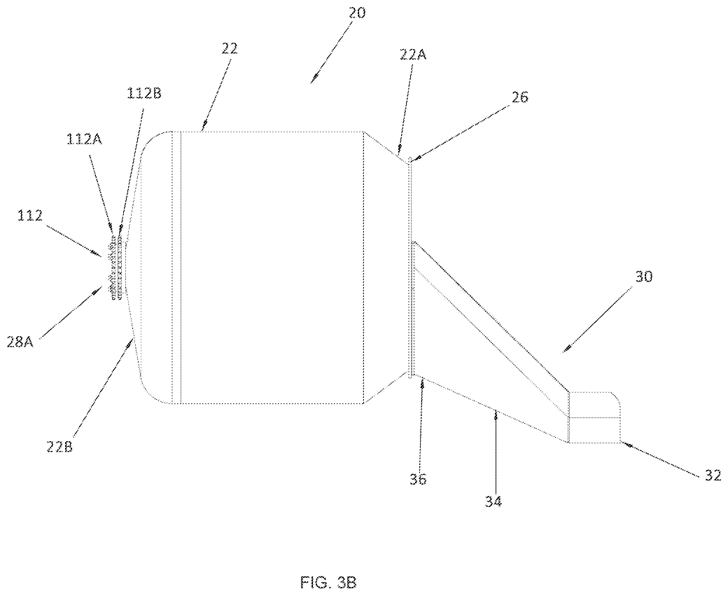

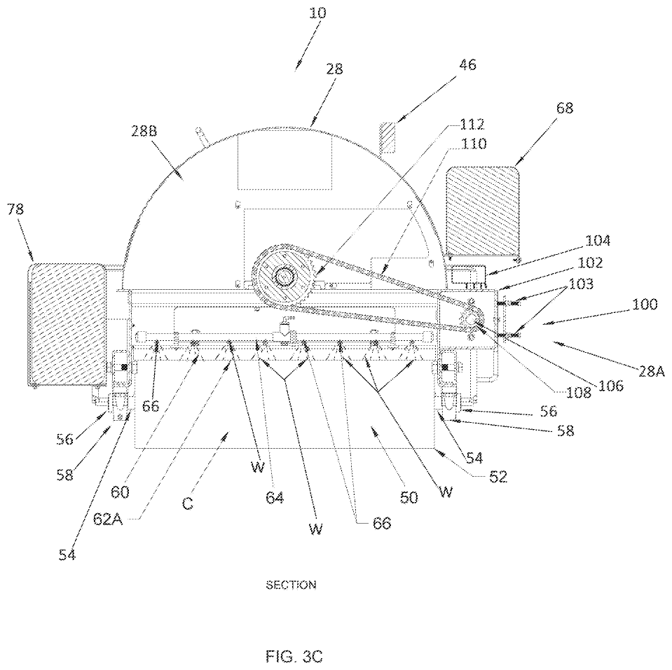

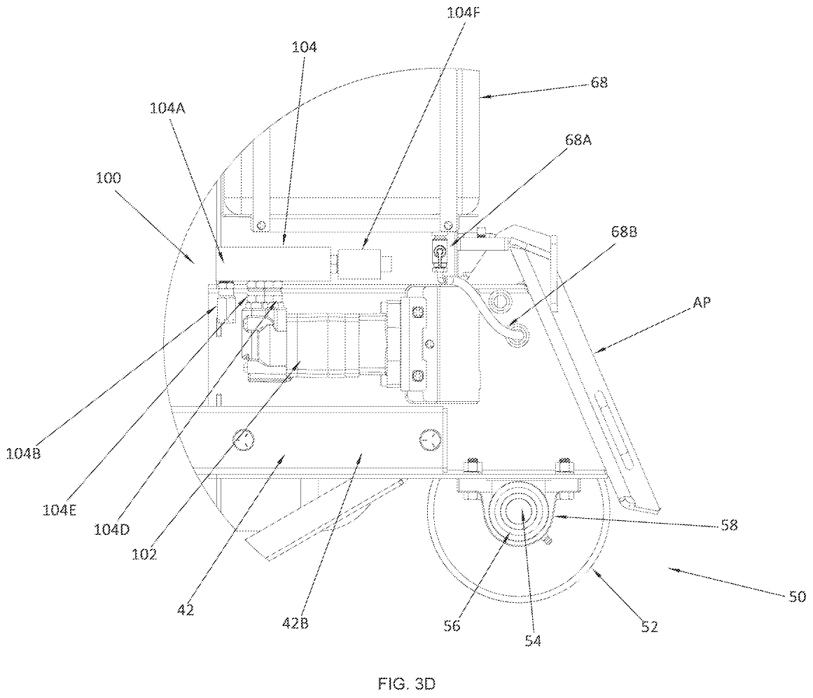

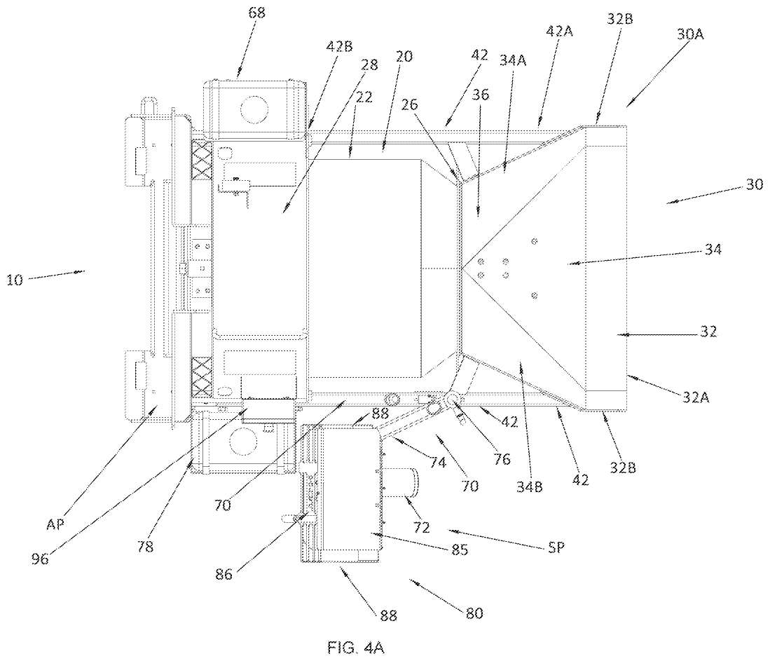

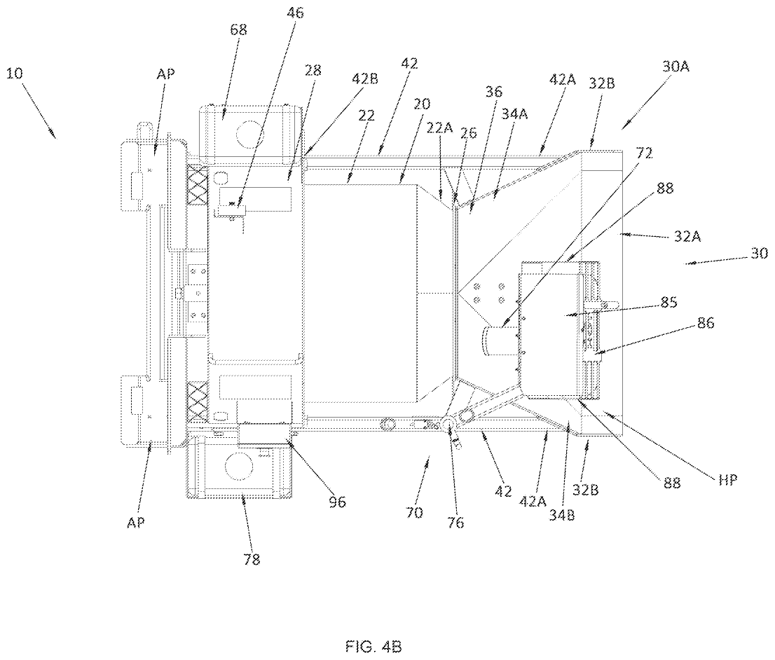

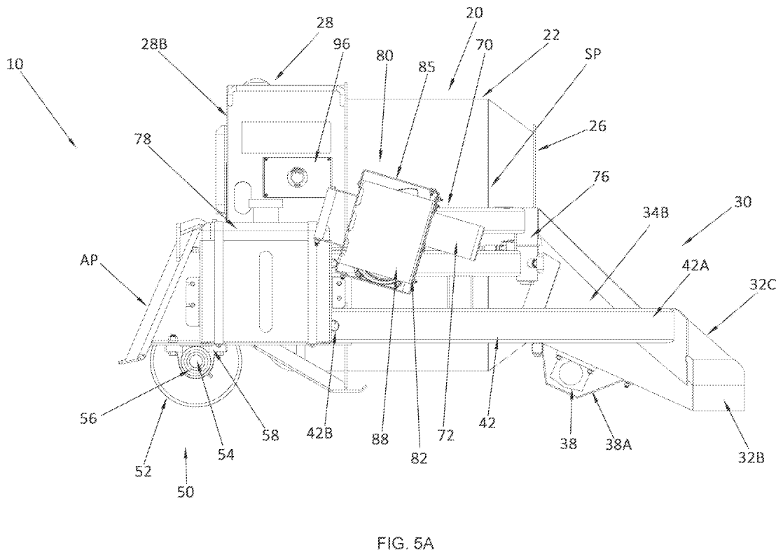

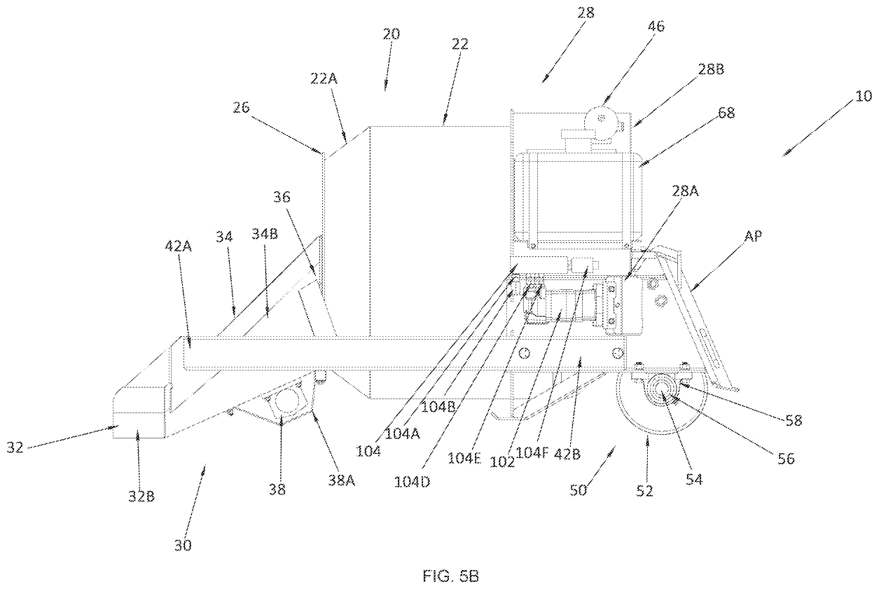

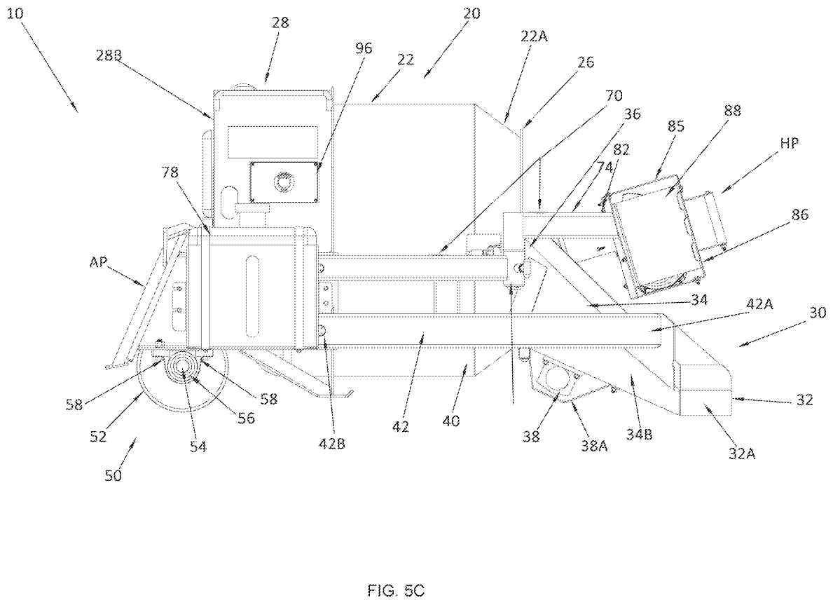

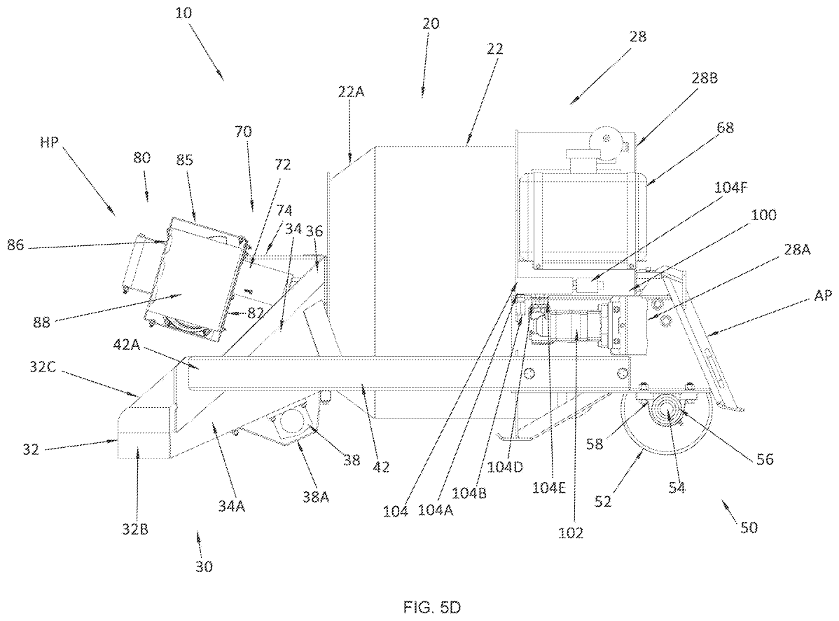

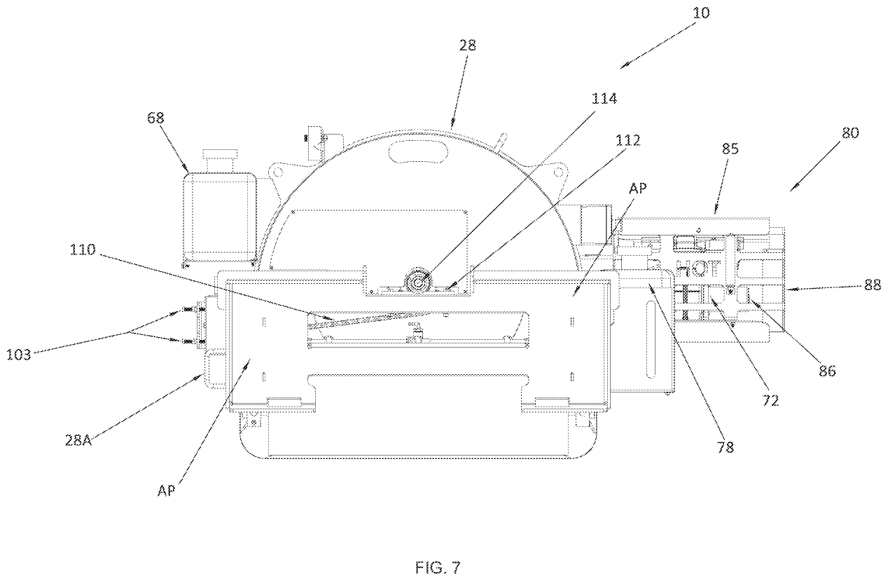

Referring to FIGS. 1A-7, an embodiment of a multiple purpose mobile mixing attachment, generally designated 10, is provided. The mobile mixing attachment 10 can be attached to a skid-steer, generally designated 12 as shown in FIGS. 1A and 1B. As shown, the skid-steer 12 can include lifting arms 12A with attachment couplers 12B for operating and moving the mobile mixing attachment 10 and a cab 12C in which an operator can sit and operate the skid-steer 12 and the mobile mixing attachment 10 to permit an operator to scrape materials off the ground or scoop the recyclable materials from the ground as shown in FIG. 1A or a pile of such material and load it into the drum 20 simply by tipping the drum 20 upwards as shown in FIG. 1B. The mixing drum 20 can comprise a body 22 that forms an internal cavity 24 and having a forward end 22A and a rear end 22B (see FIG. 3A). The mixing drum 20 can also comprise a mouth 26 at the forward end 22A of the body 22 that provides access to the internal cavity 24 of the mixing drum 20. The movement and actions of the drum 20 can be controlled by a control panel 96 or from the control panel within the cab 12C of the skid-steer 12.

The mobile mixing attachment 10 can comprise a drum chassis 28 configured to hold and rotate the mixing drum 20. The drum chassis 28 can include a lifer ring 28C. The drum chassis 28 can comprise a mixing drum drive 28A engageable with the mixing drum 20 to rotate the mixing drum 20 and a rea portion 28B that covers the rear end 22B of the body 22 of the mixing drum 20. In some embodiments, the drum drive 28A that can be separate and independent from the power system of the skid-steer 12. In some embodiments, the drum drive 28A can be powered by the power system of the skid-steer 12. The mobile mixing attachment 10 can comprise an attachment plate AP secured to the rear portion 28B of the drum chassis 28 proximal to the bottom end of the body 22 of the mixing drum 20. The attachment plate AP can be configured to engage one or more attachment couplers 12B on the lift arms 12A of the skid-steer 12 as shown in FIGS. 1A and 1B. For example, the attachment plate AP can comprise arm attachment couplers that are attachable to the attachment couplers on the lift arms 12A of the skid-steer 12.

Additionally, the mobile mixing attachment 10 can comprise a scoop 30 that can be secured to the drum chassis 28 as seen in FIGS. 1A-7. The scoop 30 can comprise a forward scooping lip 32 and a rear loading end 36 positioned in front of the mouth 26 of the mixing drum 20. The scoop 30 can allow the mobile mixing attachment 10 to scoop asphalt material from a pile or off the ground by the operator of the skid steer 12 without having a second operator to shovel the material into the mouth 26 of the mixing drum 20.

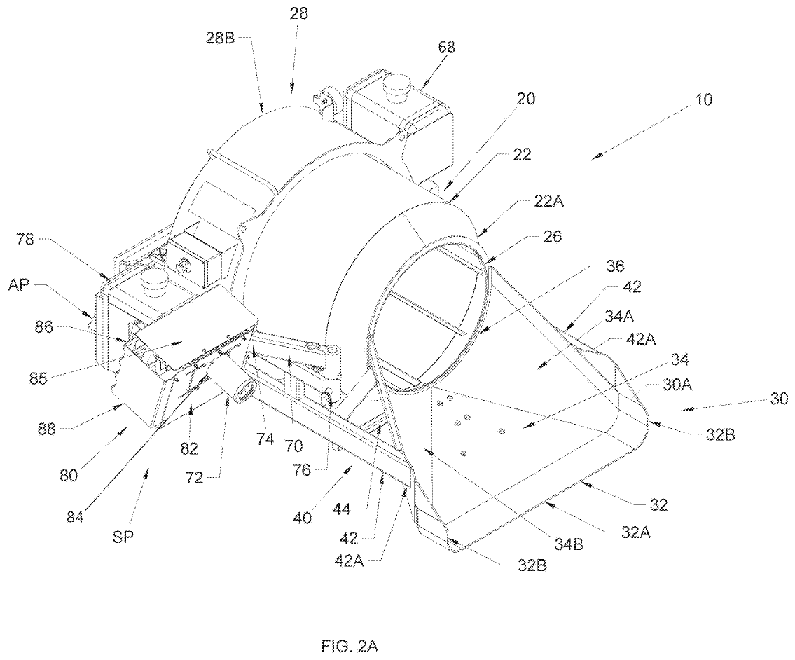

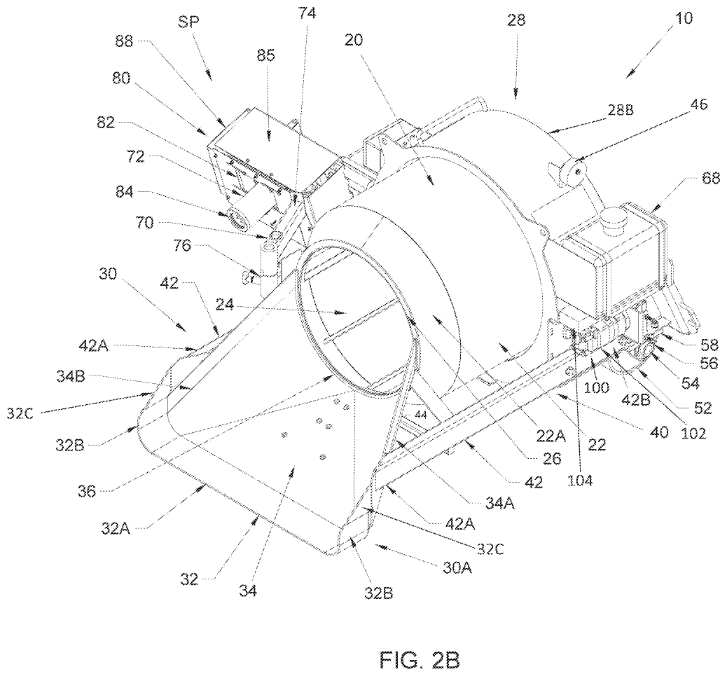

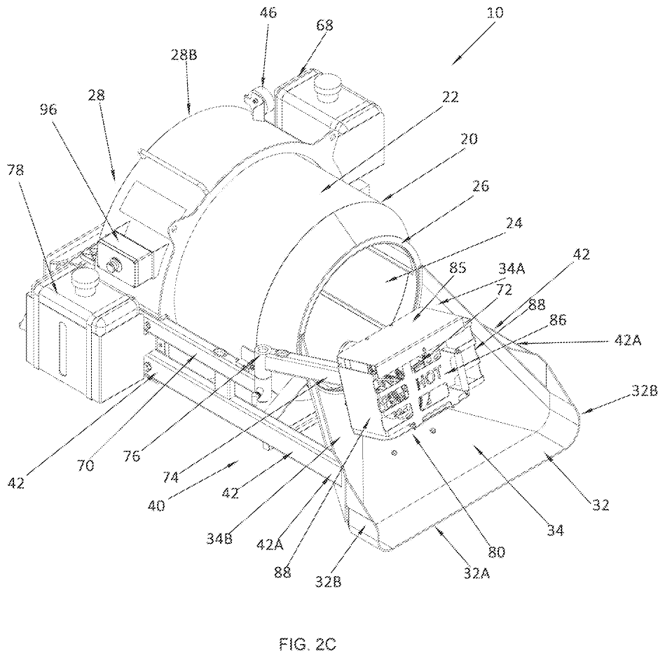

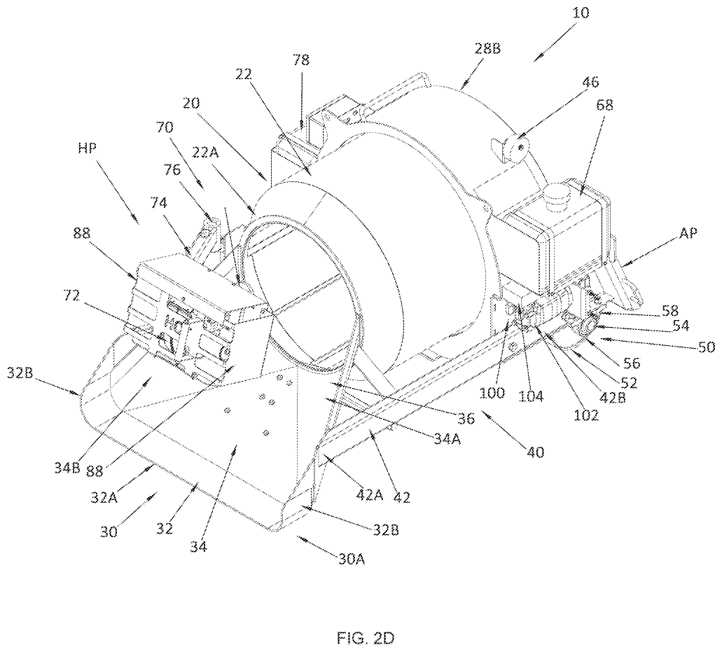

Referring to FIGS. 2A-6C, the forward scooping lip 32 of the scoop 30 can comprise a flat edge 32A extending outward across a width of a forward most portion 30A of the scoop 30 with side walls 32B extending upward on either side of the flat edge. In some embodiments, the scoop can also comprise a sloped body 34 that slopes upward from the flat edge 32 to the rear loading end 36 positioned in front of the mouth 26 of the mixing drum 20. The slope body 34 can be wider at a forward portion at the forward scooping lip 32 and more narrow at a rear portion at the rear loading end 36 positioned in front of the mouth 26 of the mixing drum 20. In some embodiments as shown, the slope body can comprise curved walls 34A, 34B that can be used to maintain material on the scoop 30. In some embodiments as shown, the curved walls 34A, 34B can help narrow the slope body 34 toward the rear loading end 36 positioned in front of the mouth 26 of the mixing drum 20. The curved walls 34A, 34B and the narrowing of the slope body 34 can help form a funnel for funneling material from the forward scooping lip 32 to the mouth 26 of the mixing drum 20.

Additionally, in some embodiments, the scoop 30 can comprise a scoop frame 40 that can hold the scoop 30 in a stationary position. The scoop frame 40 can comprise securement arms 42, each securement arm 42 having a forward end 42A and a distal end 42B. The securement arms 42 can be secured on opposing sides of the scoop 30 at the forward ends 42A and attached to the drum chassis 28 (as shown) or attachment plate AP on the distal end 42B. For example, the scoop frame 40 can be secured to the scoop 30 on opposite sides of the sloped body 34 in some embodiments as shown, for example, on the curved walls 34A, 34B. In some embodiments, the scoop frame 40 can be secured to the scoop 30 on the side walls 32B of the forward scooping lip 32 (not shown). The scoop frame 40 further comprises a brace beam 44 secured between the securement arms 42 underneath the mixing drum. Thereby, the scoop frame 40 can provide a rigidity such that, when the skid-steer 12 to which the mobile mixing attachment 10 is secured is driven into a pile of material, the scoop 30 and scoop frame 40 absorb the impact and not the mixing drum 20 of the mobile mixing attachment 10, protecting the drum 20, the drive 28A including the shaft and bearings that operate the drum 20.

Referring to FIGS. 1A, 1B, 2B, 2D, 3A-3D, 5B, 5D, 6A, and 6B, in some embodiments, the mixing drum drive 28A of the mobile mixing attachment 10 can comprise a hydraulic drive system 100. For example, the mixing drum drive 28A can comprise a hydraulic motor 102 and a dampener 104 comprising dampening block manifold 104 with an inlet connector 104B and outlet connector 104C for coupling to the hydraulic lines to be attached the hydraulic attachment lines of the skid-steer 12 and inlet motor connector 104D and outlet motor connector 104E for feeding hydraulic fluid to the hydraulic motor 102 of the hydraulic drive system 100. As seen in FIGS. 3A and 3che mixing drum drive 28A can also comprise a double sprocket and chain drive attached to a shaft 114 or shaft sleeve 116 of the mixing drum. Once the hydraulic lines are attached to the hydraulic attachment lines of the skid-steer 12, hydraulic fluid can flow through the system into the hydraulic motor 102, which rotates a motor shaft 106 attached to two drive sprockets 108A, 108B that form a double drive sprocket 108. The double drive sprocket 108 can drive a double chain 110 that is also attached to a larger double driven sprocket 112 that is, in turn, attached to the drum 20. For example, the two drive sprockets 108A, 108B each drive a chain 110. The two chains 110 each drive a large driven sprocket 112A, 112B that are attached in tandem to the drum 20. For example, the two driven sprockets 112A, 112B can be attached to the shaft 114 or a shaft sleeve 116 of the mixing drum 20. If the two driven sprockets 112A, 112B are attached to the shaft sleeve 116 of the mixing drum 20, the shaft 114 can be stationary, and the shaft sleeve 116 can ride on bearings 118. As the sprockets 112A, 112B rotate, the drum 20 is rotated.

The dampener 104 can include an aluminum block manifold 104A which contains within it a pressure relief valve connected with hydraulic fittings to the hydraulic motor 102. The drum 20 is often loaded with 500 or more pounds of material. When drum rotation is hydraulically stopped or started by an electrically controlled solenoid valve 104F. When the drum 20 is stopped, it stops almost instantly, which puts tremendous stress on the sprockets 108A, 108B, 112A, 112B and chains 110. The hydraulic dampen 104 prevents damage to sprockets 108A, 108B, 112A, 112B and chains 110 by allowing the hydraulic pressure to be relieved through a pressure relief valve during these sudden changes in drum rotation while the drum 20 is under load. The chains 110 can be kept under tension by the sprockets 108A, 108B through the use of tensioner 103.

In some embodiments, as shown in FIG. 3A, for example, the mobile mixing attachment 10 can comprise a tamping roller 50 that can be secured to the drum chassis 28 behind the bottom end 22B of the body 22 of the mixing drum 20. The tamping roller 40 can be configured to tamp and compress asphalt poured from the internal cavity 24 of the mixing drum 20 after heating and processing of the asphalt material within the drum 20 of the mobile mixing attachment 10 has occurred. The tamping roller 50 can be positioned underneath and behind the drum 20 at a position that the tamping roller 50 does not contact the ground when the scoop 30 is being used during normal scooping operations or when the mobile mixing attachment is performing loading and unloading operations. During compaction operations, the positioning of the tamping roller 50 on mobile mixing attachment 10 such that, when the mobile mixing attachment 10 is tilted with the drum 20 in an upward facing position and the skid-steer 12 lowers the mobile mixing attachment 10, the tamping roller 50 is configured to engage a surface of the ground beneath the mobile mixing attachment 10 to compact the surface of the ground. For example, the skid-steer 12 with the tamping roller 50 contacting the ground under force can then be driven forward and backward over a patch of asphalt discharged from the drum 20 of the mobile mixing attachment 10 at the site being repaired. The downward machine pressure that the skid-steer arms 12A, 12B place on the tamping roller 50 causes the tamping roller 50 to compact the fresh asphalt as the tamping roller 50 is moved back and forth.

In some embodiments, the tamping roller 50 can comprise about a 4-inch diameter heavy duty pipe 52 with an axle shaft 54 down the center supported by bearings 56 within bearing housings 58 that can be affixed to the drum chassis 28 of the mobile mixing attachment 10 for the skid-steer 12. The mobile mixing attachment 10 can further comprise a scraper 60 positioned adjacent the tamping roller 50 to remove sticky asphalt from the tamping roller 50. For example, in some embodiments, the scraper 60 comprises a first scraper blade 62A and a second scraper blade 62B with each of the first and second blades 62A, 62B positioned proximate to a circumference C of the tamping roller 50. Additionally, in some embodiments, the mobile mixing attachment 10 can also comprise a watering bar 64 with holes 66 therein positioned adjacent the tamping roller 50 to supply water on the tamping roller 50 to keep asphalt from sticking. A water tank 68 can be secured to the drum chassis 28. The water tank 68 can be connected by a water line 68A with a valve 68B thereon to the watering bar 64. The valve 68B can be configured to control the flow of water to the watering bar 64. In some embodiments, the operator can remotely control the flow of water from the water tank 68 and watering bar 64 from within the cab 12C of the skid-steer 12. For example, in some embodiments, the valve 68B can be controlled by a remote control, such as water flow on/off switches located within the cab 12C of the skid-steer 12. In some embodiments, a small electric water pump (not shown) can be used to control the flow of water from the water tank 68 and mister spray tips can be added to the holes 66 of the water bar 64, which will provide better coverage of water W on the roller surface and use 70% less water. The water pump can be controlled from the cab controller.

Further, the mobile mixing attachment 10 can comprise a movable heater mount that includes a heater support arm 70 comprising a heater 72 secured to an end 74 of the heater support arm 70 that is distal from the mixing drum 20. The heater 72 can be, for example, a burner of some type. The heater support arm 70 can be movable between a stow-away position SP (see FIGS. 2A-2B, 4A, 5A and 6A) such that the heater support arm 70 is off to a side of the mixing drum 20 and a heating position HP (see FIGS. 2C-2D, 4B, 5C-5D and 6B) with the heater 72 facing into the mouth 26 of the mixing drum 20. For example, the heater support arm 50 can be foldable between a stow-away position SP and a heating position HP.

In more detail, the mobile mixing attachment 10 can comprise the heater support arm 70 that allows contents placed within the mixing drum 20 of the mobile mixing attachment 10 to be heated to a proper temperature for mixing different kinds of asphalt. The heater support arm 70 has heater 72, which serves as a heat source. For example, the heater 72 can comprise a flame torch that can generate a large amount of heat within the drum 20. The heater support arm 70 can be pivotally mounted proximal to the mouth 26 of the drum 20 and can swing into a position that allows heat generated by the heater 32 to enter the mixing drum 20 through a central portion of the mouth 26 of the mixing drum 20. The mixing drum 20 can be insulated to help retain heat within the internal cavity 24 of the mixing drum 20 when heating asphalt material within the drum 20, while keeping the temperature of the exterior of the mixing drum 20 at a lower temperature.

For example, the heater support arm 70 can be pivoted around a locking pivot 76 to lock the heater support arm 70 and heater 72 in the stow-away position SP when dumping the contents of the drum 20 as shown in FIGS. 2A-2B, 4A, 5A-5B and 6A or when mixing cement or concrete. The heater support arm 70 can be pivoted around a locking pivot 76 to lock the heater support arm 70 and heater 72 in the heating position HP as shown FIGS. 2C-2D, 4B, 5C-5D and 6B when heating asphalt mix that has been loaded into the mixing drum 20. In some embodiments, the heater support arm 70 can have an activation switch that prevents the heater 72 from producing heat until the heater support arm 70 is locked into the heating position HP. Timers for controlling the amount of time that the heater 72 is activated can be in operable communication with the heat source of the heater 72. The heater support arm 70, the heater on/off switches, and timers can be activated by the operator at the skid-steer 12, such as at controls located in proximity to the mixing drum 20, or in the cab 12C of a skid-steer 12. In some embodiments, the heater on/off switches, and timers can be activated by the operator remotely by a wired tether control or wireless control. For example, the operator may be able to remotely control the heater 72 from within the cab 12C of a skid-steer 12. For instance, the heater 72 can be controlled by a remote control from within the cab 12C, such as heater on/off switches located within the cab 12C of the skid-steer 12.

In some embodiments, power for the heater 72 can be supplied by a battery on the skid-steer 12. In some embodiments, the battery can be recharged by the components on or part of the skid-steer 12. For example, in some embodiments, the battery can be charged by an alternator (not shown) coupled to a hydraulic motor attached to hydraulic lines with quick connectors that attach directly to the hydraulic quick connects of the skid-steer 12. In some embodiments, power for the heater 72 can be supplied by a generator that is operated from and secured to the skid-steer 12. In some embodiments, an independent power supply can be provided to supply power to the heater 72. In particular, an independent fuel tank 78 that can be secured on the drum chassis 28 as shown in FIGS. 2A, 2C, 4A-4B, 5A, 5C, 6A, 6B and 7 can be provided to supply fuel to the heater 72. The heater arm 70 of the mobile mixing attachment 10 can comprise a heater casing 80 surrounding an exterior of the heater 72 that provides space between the heater casing 80 and the heater 72. The heater casing 80 comprising a front wall 82 with a flame exit, or heater nozzle, aperture 84 therein, a vented back wall 86 and side walls 88 and a hinged top door 85 that provides access to the heater 72 within the heater casing 80.

During use of the mobile mixing attachment 10, the operator can perform all the operations from within the cab 12C of the skid-steer 12, including but not limited to full control of the mixing drum rotation speed/direction, heating, and dumping, directly from an operator console. Different operations can be used to process asphalt and to perform different types of needed repairs. The different operations can depend on the type of asphalt used and how it is supplied to the mobile mixing attachment 10. For example, if a pile of RAP is provided for making the repairs, the arms of the skid-steer 12 can position the mobile mixing attachment 10 in a scooping position and asphalt material, which may include millings, aggregate, and/or RAP can be scooped up by the scoop 30 during a scooping operation. After scooping has occurred and the desired asphalt material resides on the scoop 30, a mixing operation can occur which can include several steps. Once scooped, the asphalt material needs to enter the mixing drum 20. The mobile mixing attachment 10 can be tilted upward so that the drum 20 is facing upward to allow the asphalt material to slide down the scoop 30, through the mouth 26 and into the internal cavity 24 of the mixing drum 20. A tiltometer 46 can be used to measure the amount of tilt of the drum 20.

To facilitate the slide of the asphalt material on the scoop body 34 to slide into the internal cavity 24 of the mixing drum 20, the mobile mixing attachment 10 can further comprise a vibrator 38 that vibrates the scoop body 34. The vibrator 38 can be enclosure by a vibrator casing 38A. The vibration caused by the vibrator 38, in turn causes the asphalt material on the scoop body 34 of the scoop 30 to more readily slide down the scoop body 34 and the rear loading end 36 toward the mouth 26 and the internal cavity 24 of the mixing drum 20 when the mobile mixing attachment 10 can be tilted upward. Additionally, the vibrator 38 can be used to vibrate the scoop body 34, or the shovel platform, during dispensing of heated material from the mixing drum 20 to feed the material off the scoop body 34 to the repair site. In some embodiments, the operator can remotely control the vibrator 38 from within the cab 12C of the skid-steer 12. For example, the vibrator 38 can be controlled by a remote control, such as vibrator on/off switches located within the cab 12C of the skid-steer 12.

After the material enters the internal cavity 24 of the mixing drum 20, the drum 20 can be lowered and the heater support arm 70 can be moved and locked into the heating position HP for heating the mix in the rotating mixing drum 20. Once the material reaches the desired temperature, the operator can stop the heater 72 and can lock the heater support arm 70 in the idle position, or stow-away position, SP. The operator can then drive the skid steer 12 to the repair site and can discharge the mix in the appropriate location by tilting the mobile mixing attachment 10 downward at the desired location during a pouring or discharge operation. For a compaction operation, the mobile mixing attachment 10 can then be tilted with the drum 20 in an upward facing position and the skid-steer 12 can lower the mobile mixing attachment 10, so that the tamping roller 50 contacts the ground under force with the downward machine pressure that the skid-steer arms 12A, 12B place on the tamping roller 50 causing the tamping roller 50 to compact the fresh newly poured asphalt as the skid-steer 12 moves the tamping roller 50 back and forth.

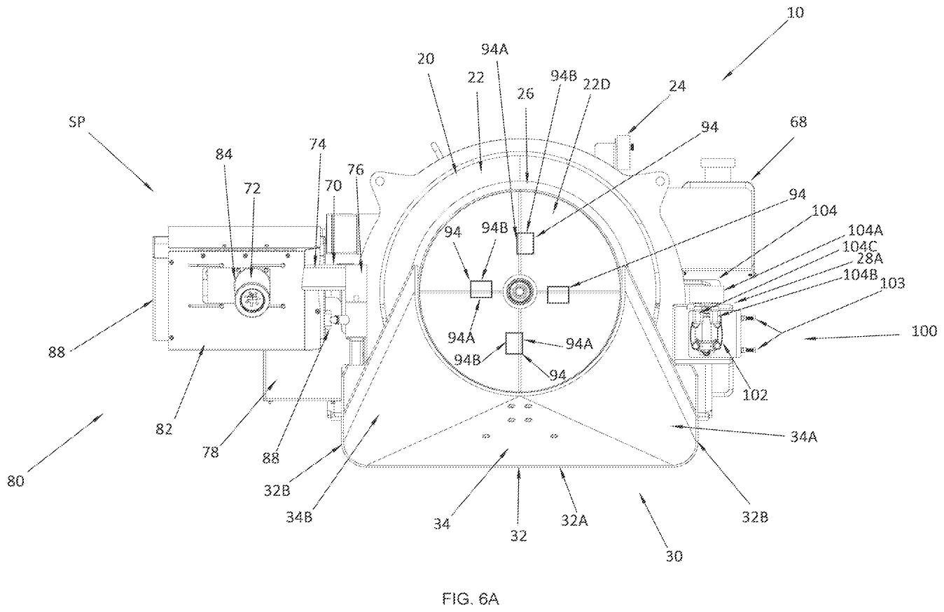

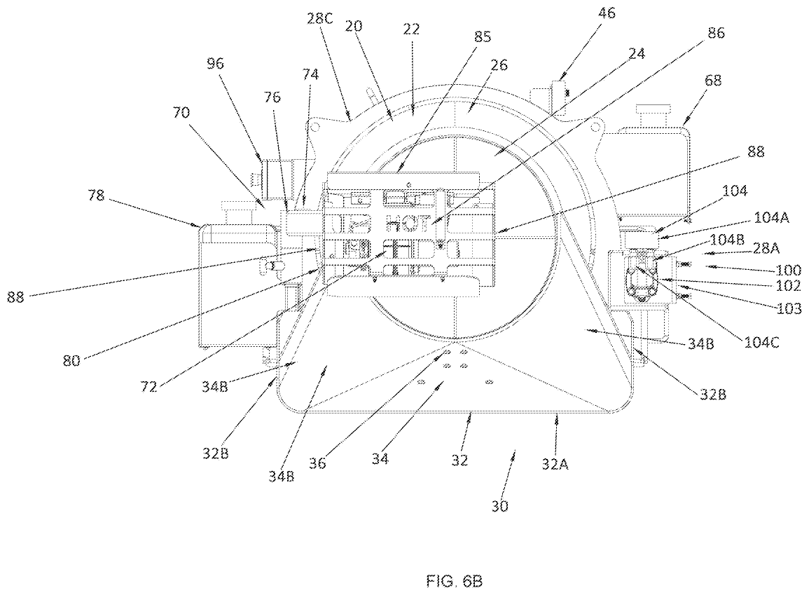

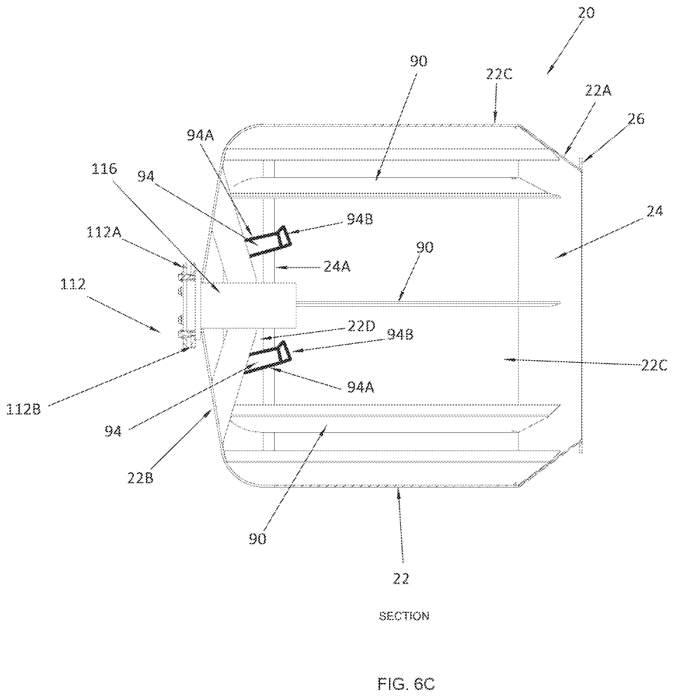

As shown in FIGS. 3A and 6A, the mixing drum 20 of the mobile mixing attachment 10 can have different internal features within the internal cavity 24 of the mixing drum 20 that facilitate the processing of either asphalt material or cement, concrete or flowable fill products. For example, the various types of flights can be included in the internal cavity 24 of the mixing drum 20, including, but not limited to, back wall flights on the back wall of the interior of the body 22 of the mixing drum 20, sidewall flights within the cylindrical portion of the interior of the body 22 of the mixing drum 20, and/or cone flights that are secured within the cone portion of the interior of the body 22 of the mixing drum 20. In some embodiments, these flights can be changeable so that specific flights that perform specific functions can be interchangeable for the specific types of flights, i.e., back wall flights, sidewall flights, or cone flights. The various types of flights can have different shapes and can have different heights. For example, some embodiments of flights can be a reverse L-shaped. Some embodiments of flights can be angled at different heights at about a 45 degree angle. Some embodiments of flights can be angled at a first bend at about a 45 degree angle and then angled again at a second bend at about a 45 degree angle. Further, in some embodiments, the flights can be angled at different angles and/or multiple angles. For example, in some embodiments, the flights can be angled at about 90 degrees. In some embodiments, the flights can be angled at an angle that is less than about 45 degrees or at angle that is between about 45 degrees and about 90 degrees. In some embodiments, the flights can comprise multiple bends therein at the same or different angles along the body of the respective flight. Different shaped flights can be used in the same drum. In the cone portion of the body 22 of the mixing drum 20, the cone flight can comprise short flights in the cone that are angled in a direction of rotation during mixing but angled in the direction opposite the direction of rotation during dispersion/discharge.

For example, in some embodiments, the mixing drum 20 can comprise one or more sidewall lifters 90 extending inward from the body 22 of the mixing drum into the internal cavity 24 for agitating the contents poured or otherwise loaded in the internal cavity 24 of the mixing drum 20. The sidewall lifters 90 can be inward from the body 22 of the mixing drum 20 and extend into the internal cavity 24. For example, the sidewall lifters 90 can extend outward from side walls 22C of the body 22 of the mixing drum 20 into the internal cavity 24. The sidewall lifters 90 are useful for agitating the contents loaded in the internal cavity 24 of the drum 20 for mixing, processing and discharging, concrete, asphalt and flowable fill products. This allows a single mixing device 10 to be used for all three products: flowable fill, different types of cement, and different types of asphalt.

Additionally, each of the sidewall lifters 90 can comprise a barb 92 extending outward at angle from the lifter 90. In some embodiments, one barb 92 can extend outward from each lifter 90. In some embodiments, two, three, or four barbs 92 can extend outward from each lifter 90. The one or more barbs 92 can form sharp points that can rip open bags of aggregate used in making asphalt that can be inserted, for example, thrown, into the mixing drum 20 of the mobile mixing attachment 10. For example, once the bags are placed in the mixing drum 20 of the mobile mixing attachment 10 and the mixing drum 20 is rotated, the one or more barbs 92 on the sidewall lifters 90 will tear open the bags of aggregate as the mixing drum 20 turns.

Further, the body 22 of the mixing drum 20 can comprise a back wall 22D that forms the rear 24A of the internal cavity 24. The back wall 22D can comprise back wall flights 94 that extend outward from the back wall 22D of the body 22 of the mixing drum 20 into the internal cavity 24. In particular, the back wall flights 94 can comprise four flights 94 that extend outward into the internal cavity 24 to keep the asphalt material as it is heated moving back toward the center and the mouth 26 of the mixing drum 20 instead of letting it settle toward the rear 24A of the internal cavity 24. The back wall back wall flights 94 can be in a variety of different shapes to facilitate the movement of the asphalt material being processed. As an example, in some embodiments, each back wall flight 94 can have a first portion 94A that extends perpendicular from the back wall 22D of the body 22 of the mixing drum 20 and a second portion 94B that extending at an angle from the first portion.

Thus, as explained above, drum fighting of various shapes and heights can be provided within the mixing drum 20 to facilitate the optimization of mixing and heating of material within the mixing drum 20.

The mobile mixing attachment 10 can be used to process flowable fill, concrete, or some other cement-based product or could be used to process asphalt. For example, when the heater support arm 70 is in the stow-away position SP, the mixing drum 20 can process flowable fill, concrete, or some other cement-based product in the internal cavity 24 of mixing drum 20. Additionally, the mixing drum 20 of the same single mobile mixing attachment 10 can be used to process asphalt by moving the heater support arm 30 into the heating position HP with the heater 72 facing into the mouth 26 of the mixing drum 20 to heat the asphalt material loaded into the internal cavity 24 of mixing drum 20 through the mouth 26 as shown in FIGS. 2C-2D, 4B, 5C-5D and 6B. Thus, the single mobile mixing attachment 10 can process both a flowable fill, concrete, or some other cement-based product and an asphalt product with only a cleaning between the mixings.

These and other modifications and variations to the present subject matter may be practiced by those of ordinary skill in the art, without departing from the spirit and scope of the present subject matter, which is more particularly set forth herein above. In addition, it should be understood the aspects of the various embodiments may be interchanged both in whole and in part. Furthermore, those of ordinary skill in the art will appreciate that the foregoing description is by way of example only, and is not intended to limit the present subject matter.

1. A mobile mixing attachment for use on a skid-steer, the mobile mixing attachment comprising:
a rotatable mixing drum comprising a body that forms an internal cavity and having a forward end and a bottom end, the mixing drum comprising a mouth at the forward end of the body that provides access to the internal cavity of the mixing drum;
a drum chassis configured to hold and rotate the mixing drum;
an attachment plate secured to a rear portion of the drum chassis proximal to the bottom end of the body, the attachment plate configured to engage one or more attachment couplers on lift arms of a skid-steer; and
a scoop comprising a forward scooping lip and a rear loading end positioned in front of the mouth of the mixing drum, the scoop being secured to the drum chassis.

2. (canceled)

3. The mobile mixing attachment according to claim 1, wherein the forward scooping lip of the scoop comprises a flat edge extending outward across the width of a forward most portion of the scoop with side walls extending upward on either side of the flat edge; and
wherein the scoop comprises a sloped body that slopes upward from the flat edge to the rear loading end positioned in front of the mouth of the mixing drum.

4. The mobile mixing attachment according to claim 3, wherein the slope body is wider at a forward portion at the forward scooping lip and more narrow at the rear loading end positioned in front of the mouth of the mixing drum.

5. The mobile mixing attachment according to claim 4, wherein the slope body comprises curved walls that narrow the slope body toward the rear loading end positioned in front of the mouth of the mixing drum to form funnel for funneling material from the forward scooping lip to the mouth of the mixing drum.

6. (canceled)

7. The mobile mixing attachment according to claim 1, further comprising a mixing drum drive for rotating the mixing drum within the chassis, wherein the mixing drum drive comprises a hydraulic system that includes a hydraulic motor and a dampening block manifold with inlet and outlet connectors for coupling to hydraulic lines to be attached the hydraulic attachment lines of the skid-steer and inlet and outlet motor connectors for feeding hydraulic fluid to the hydraulic motor of the hydraulic drive system.

8. The mobile mixing attachment according to claim 1, further comprising a tamping roller secured to the drum chassis behind the bottom end of the body of the mixing drum, the tamping roller configured to tamp and compress asphalt poured from the internal cavity of the mixing drum.

9. The mobile mixing attachment according to claim 8, further comprising a scraper positioned adjacent the tamping roller to remove the sticky asphalt from the tamping roller.

10. The mobile mixing attachment according to claim 9, wherein the scraper comprises a first scraper blade and a second scraper blade with each of the first and second blades positioned proximate to a circumference of the tamping roller.

11. The mobile mixing attachment according to claim 8, further comprising a watering bar with holes therein positioned adjacent the tamping roller to supply water on the tamping roller to keep asphalt from sticking.

12. The mobile mixing attachment according to claim 11, further comprising a water tank secured to the drum chassis, the water tank connected by a water line with a valve thereon to the water bar, the valve configured to control the flow of water to the water bar.

13. The mobile mixing attachment according to claim 8, wherein the tamping roller comprises about a 4-inch diameter heavy duty pipe with an axle shaft down the center supported by bearings within bearing housings that are affixed to the drum chassis of the mobile mixing attachment for the skid-steer.

14. The mobile mixing attachment according to claim 8, wherein the tamping roller is positioned underneath the drum at a position that the tamping roller does not contact the ground with the scoop being used during normal scooping, loading, and unloading operations.

15. The mobile mixing attachment according to claim 8, wherein during compaction operations, the tamping roller is positioned on mobile mixing attachment such that, when the mobile mixing attachment is tilted with the drum in an upward facing position and lowered, the tamping roller is configured to engage a surface of the ground beneath the mobile mixing attachment to compact the surface of the ground.

16. (canceled)

17. The mobile mixing attachment according to claim 1, wherein the scoop comprises securement arms, each securement arm having a forward end and a distal end, the securement arms secured on opposing sides of the scoop at the forward ends and attached to the drum chassis on the distal end; and
wherein the securement arms hold the scoop stationary with the rear loading end positioned in front of the mouth of the mixing drum such that material to be processed picked up by the scoop slides down the scoop into the mouth of the mixing drum.

18. The mobile mixing attachment according to claim 1, wherein the scoop comprises a scoop frame that holds the scoop in a stationary position.

19. The mobile mixing attachment according to claim 18, wherein the scoop frame comprises securement arms, each securement arm having a forward end and a distal end, the securement arms secured on opposing sides of the scoop at the forward ends and attached to the drum chassis on the distal end.

20. The mobile mixing attachment according to claim 19, wherein the scoop frame further comprises a brace beam secured between the securement arms underneath the mixing drum.

21. The mobile mixing attachment according to claim 20, wherein the scoop frame provides a rigidity such that, when the skid-steer to which the mobile mixing attachment is secured is driven into a pile of material, the scoop and scoop frame absorb the impact and not the drum, protecting the drum, shaft and bearings that operate the drum.

22. (canceled)

23. The mobile mixing attachment according to claim 1, further comprising:
a heater support arm comprising a heater secured to an end of the heater support arm that is distal from the mixing drum, the heater support arm being movable between a stow-away position such that the heater support arm is off to a side of the mixing drum and a heating position with the heater facing into the mouth of the mixing drum; and
a heater casing surrounding an exterior of the heater that provides space between the heater casing and the heater, the heater casing comprising a front wall with a flame exit aperture therein, a vented back wall and side wall and a hinged top door that provides access to the heater within the heater casing.

24. The mobile mixing attachment according to claim 1, further comprising a mixing drum drive engageable with the mixing drum to rotate the mixing drum, the mixing drum drive comprising a motor with a motor shaft having a double drive sprocket on the motor shaft that drives a double chain drive to drive a double driven sprocket attached to the mixing drum.

25-26. (canceled)

27. The mobile mixing attachment according to claim 1, wherein the body of the mixing drum comprises a back wall that forms the rear of the internal cavity, the back wall comprising back wall flights that extend outward from the back wall into the internal cavity; and
wherein the back wall flights comprise four back wall flights, each back wall flight having a first portion extending perpendicular from the back wall of the body of the mixing drum and a second portion extending at an angle from the first portion.

28. (canceled)

29. The mobile mixing attachment according to claim 1, wherein each of the sidewall flights comprises a barb extending outward at angle from the baffle configured to rip open bags of aggregate used in making asphalt.

30-50. (canceled)
